(19) United States
(12) Patent Application Publication
(10) Pub. No.: US 2021/0140591 A1
(43) Pub. Date: May 13, 2021

(54) ELONGATED FRAME LAMP

(71) Applicant: NINGBO JINGHUI OPTO-ELECTRONIC CO., LTD., Zhejiang Province (CN)

(72) Inventors: Guohui BAI, Zhejiang Province (CN); Guohuan FENG, Zhejiang Province (CN)

(73) Assignee: NINGBO JINGHUI OPTO-ELECTRONIC CO., LTD., Zhejiang Province (CN)

(21) Appl. No.: 16/682,707

(22) Filed: Nov. 13, 2019

(51) Int. Cl. F21K 9/275; F21K 9/272; F21V 23/04; F21S 8/06; F21V 17/10; F21K 9/278; F21V 29/70; F21V 23/00; F21V 23/06

(52) U.S. Cl. CPC F21K 9/275; F21K 9/272; F21V 23/04; F21S 8/06; F21Y 2115/10; F21K 9/278; F21V 29/70; F21V 23/003; F21V 23/06; F21V 17/10

(57) ABSTRACT

The present new invention discloses an elongated frame lamp, comprising a lamp body, a lamp board and a lampshade; the aforementioned lamp body has a first plug on one end and a second plug on the other end; the aforementioned lamp board is placed between the lamp body and the lampshade; wherein the aforementioned lamp board and lamp body are separated through an insulation tape; a heat-conducting dual side insulation tape resistant to high voltages up to 4000V is used to securely fasten the light strip into an elongated aluminum housing groove. As a core part, the heat-conducting dual side insulation tape resistant to high voltages can fully achieve a safe creepage distance in ETL accreditation.

### TECHNICAL FIELD

The present new invention relates to the LED frame lamp technical field and in particular, relates to an elongated frame lamp.

### BACKGROUND OF INVENTION

An LED mainly comprises an “upper lamp head structure” and a “bottom lamp tube structure.” Such an existing frame lamp has the following defects:

1. If an isolated power supply is used, the purpose of having a narrower LED lamp board strip can be achieved, but the cost of such an isolated power supply is high.

2. If a non-isolated power supply is used, the width of the LED lamp board strip must be increased to meet the requirements for a safe creepage distance in ETL accreditation. An increase in the width of the lamp board is structurally not permissible.

### CONTENTS OF THE NEW INVENTION

### (I) Technical Issues to be Resolved

The purpose of the present new invention is to overcome the aforementioned weaknesses by providing an elongated frame lamp.

### (II) Technical Solution

To achieve the aforementioned purpose, the elongated frame lamp in the present new invention comprises a lamp body, a lamp board and a lamp shade; the aforementioned lamp body has a first plug on one end and a second plug on the other end; the aforementioned lamp board is placed between the lamp body and the lampshade; wherein the aforementioned lamp board and lamp body are separated through an insulation tape; the outer side of the aforementioned first plug has a pull switch. The upper end of the aforementioned first plug has a power plug end.

Further, a pair of hook screws are symmetrically placed on the upper part of the aforementioned lamp body. The upper part of the aforementioned hook screws are connected to an S-shaped hanging hook.

Further, the installation side of the lamp body and the lamp board is a groove with a concave; the backside of the aforementioned insulation tape is bonded to the groove and the front side is bonded to the lamp board.

Further, at least a pair of slide ways are placed on the two sides of aforementioned groove. There are insertion lampshade parts on the two sides of the aforementioned lampshade. Such insertion parts are inserted is along such slide ways.

Further, a drive assembly is installed in the lamp body. An AC-DC constant current circuit is built the aforementioned drive assembly.

### (III) Beneficial Effects

Compared with the existing art, the technical solution of the present new invention has the following advantages: The elongated frame lamp in the present application is a non-isolated power supply as well as a lamp with a narrower LED lamp board strip. A heat-conducting dual side insulation tape resistant to a high voltage of up to 4000V is used to securely fasten the lamp strip into an elongated aluminum housing groove. As a core part, the heat-conducting dual side insulation tape resistant to high voltages can fully achieve a safe creepage distance in ETL accreditation.

### BRIEF DESCRIPTION OF THE DRAWINGS

FIG. 1 is an explosive view of the elongated mobile frame lamp in the present new invention; and

FIG. 2 is a structural diagram of the cross-section of the elongated mobile frame lamp in the present new invention.

### EMBODIMENTS

In combination with the attached drawings and embodiments, the following is a further and detailed description of the specific embodiments of the present new invention. The following embodiment is used to describe the present invention, but should not be used to limit the scope of the present new invention.

As illustrated in FIG. 1 and FIG. 2, the elongated frame lamp in the present new invention comprises lamp body 1, lamp board 2 and lampshade 3; the aforementioned lamp body 1 has a first plug 4 on one end and a second plug 5 on the other end. Plugs are common designs for a is frame lamp; the aforementioned lamp board 2 is placed between lamp body 1 and lampshade 3; wherein the aforementioned lamp board 2 and lamp body 1 are separated through an insulation tape 6; the outer side of the aforementioned first plug 4 has a pull switch 7. The upper end of the aforementioned first plug 4 has a power plug end to supply power for the frame lamp.

A pair of hook screws 9 are symmetrically placed on the upper part of the aforementioned lamp body 1. The upper part of the aforementioned hook screws 9 are connected to an S-shaped hanging hook 10, used to hang the entire frame lamp.

The installation side of the lamp body 1 and lamp board 2 is a groove 11 with a concave; the backside of the aforementioned insulation tape 6 is bonded to groove 11 and the front side is bonded to lamp board 2. In the present embodiment, groove 11 has extended surfaces and a bottom surface on the two sides. Insulation tape 6 happens to cover the extended services in the bottom surface. Lamp board 2 is affixed on the bottom surface of groove 11.

At least a pair of slide ways 12 are placed on the two sides of aforementioned groove 11. There are insertion lampshade parts 13 shaped like hooks on the two sides of the aforementioned lampshade 3. Such insertion parts 13 are inserted along such slide ways 12.

A drive assembly (not shown in the Figures) is installed in lamp body. An AC-DC constant current circuit is built in the drive assembly. Constant current circuits are common power supply methods in the frame lamp field and we will not elaborate on them here.

Insulation tape 6 in the present application is a dual side insulation tape 6 and is characterized in that it conducts heat and is resistant to high voltages up to 4000V.

The elongated frame lamp in the present application is a non-isolated power supply as well as a lamp with a narrower LED lamp board strip. It uses a heat-conducting dual side insulation tape that is resistant to high voltage of up to 4000V to securely fasten the lamp strip into an elongated aluminum housing groove. As a core part, the heat-conducting dual side insulation tape resistant to high voltages can fully achieve a safe creepage distance in ETL accreditation.

In summary, the aforementioned embodiment is not a restrictive embodiment of the present new utility box model. All modifications or equivalent variations made by those skilled in the art based on the substantive contents of the present new invention will be within the technical scope of the present new invention.

1. An elongated frame lamp, comprising:
a lamp body, a lamp board and a lampshade;
wherein the lamp body has a first plug on one end and a second plug on another end;
the lamp board is placed between an entirety of the lamp body and the lampshade;
wherein the lamp board and the lamp body are separated through an insulation tape;
an outer side of the first plug has a pull switch; an upper end of the first plug has a power plug end;
wherein an installation side of the lamp body and the lamp board is a groove with a concave; and a backside of the insulation tape is bonded to the groove and a front side thereof is bonded to the lamp board; and
wherein at least a pair of slanted slide ways are placed on two sides of the groove; there are insertion lampshade parts on two sides of the lampshade; the insertion lampshade parts are inserted along the slide ways.

2. The elongated frame lamp according to claim 1, wherein a pair of hook screws are symmetrically placed on an upper part of the lamp body; and an upper part of the hook screws is connected to an S-shaped hanging hook.

3. (canceled)

4. (canceled)

5. The elongated frame lamp according to claim 1, wherein a drive assembly is installed in the lamp body; an AC-DC constant current circuit is built in the drive assembly.

6. An elongated frame lamp with a non-isolated power supply, comprising:
a lamp body, an LED lamp board strip and a lampshade;
wherein the lamp body has a first plug on one end and a second plug on another end;
the LED lamp board strip is placed between an entirety of the lamp body and the lampshade;
wherein the LED lamp board strip and the lamp body are separated through an heat-conducting dual side insulation tape resistant to a high voltage of up to 4000V;
an outer side of the first plug has a pull switch; an upper end of the first plug has a power plug end;
an installation side of the lamp body and the lamp board is a groove with a concave; and
a backside of the insulation tape is bonded to the groove and a front side thereof is bonded to the lamp board; and
wherein at least a pair of slanted slide ways are placed on two sides of the groove; there are insertion lampshade parts on two sides of the lampshade; the insertion lampshade parts are inserted along the slide ways.
